(19) United States
(12) Patent Application Publication
(10) Pub. No.: US 2013/0000539 A1
(43) Pub. Date: Jan. 3, 2013

(54) IMPROVED LANDING SYSTEM

(75) Inventors: Amit Wolff, Zur Moshe (IL); Lior Zivan, Hadera (IL); Guy Dekel, Katzir (IL)

(73) Assignee: ISRAEL AEROSPACE INDUSTRIES LTD., Lod (IL)

(21) Appl. No.: 13/583,781

(22) PCT Filed: Mar. 17, 2011
(86) PCT No.: PCT/IL11/00261

§ 371 Date: Sep. 10, 2012

(30) Foreign Application Priority Data
Mar. 22, 2010 (IL) 204654

(51) Int. Cl. B63B 35/53; B64F 1/00

(52) U.S. Cl. 114/261; 244/110 E; 244/183

(57) ABSTRACT

A portable aircraft landing system comprises an inflatable mat provided with gas outlets, in cooperation with inflation apparatus.

### FIELD OF THE INVENTION

The present invention relates to the landing of aircrafts. More particularly, the invention relates to the landing of aircrafts where no runway is available for landing. Still more particularly, the invention relates to the landing of an aircraft on an inflated mat.

### BACKGROUND OF THE INVENTION

Manned and unmanned aircrafts are often required to land in a small landing space where no landing runway is available, either because of a planned recovery of the aircraft in such area, e.g. a mountain area, or because of unexpected technical problems. In order to enable the aircraft to land in difficult areas or on sea, many aircraft are provided with dedicated equipment, such as parachutes and airbags, the former being actuated at a given height above the ground, and the latter being inflated a few instants before the aircraft hits the ground. A severe disadvantage of such airborne equipment is that its weight is substantial and it limits either the payload that the aircraft can carry, or the autonomy of the flight, or both. Furthermore, the reliability of the airborne system is also sometimes compromised by the absence of suitable landing means. Alternative landing arrangements include the provision of vertical nets into which the aircraft flies and is captured, and the capturing of the aircraft by the engagement of a hook on the fuselage with a cable on the ground. These two arrangements require static preparations on the ground, which do not allow for a swift change of landing location and are not suitable for difficult terrain.

It is therefore clear that it would be highly advantageous to be able to provide landing equipment that does not impose such heavy burden on the aircraft, with the resulting limitations.

It is an object of the present invention to provide a method and system that overcome the disadvantages of the prior art.

It is another object of the present invention to provide a method and system that can be exploited easily and quickly to allow an aircraft to land in difficult grounds, and are cost efficient.

Other objects and advantages of the invention will become apparent as the description proceeds.

### SUMMARY OF THE INVENTION

In one aspect the invention is directed to a portable aircraft landing system, comprising an inflatable mat provided with gas outlets, in cooperation with inflation apparatus.

Inflating the mat can be accomplished in a variety of ways. In one embodiment of the invention the inflation apparatus includes a blower and the gas is air. In another embodiment of the invention the inflation apparatus includes a pressurized gas bottle. When a bottle is used, the gas can be any suitable gas, such as N₂, CO₂ and air, as well as any other gas or mixture of gases.

In another aspect the invention is directed to a landing system, which is suitable for landing on water, wherein the inflatable mat is coupled to, and provided above a floating surface. In one embodiment of the invention the floating surface is inflatable, but other arrangements (such as foam-filled pads) can be employed.

In one embodiment of the invention the inflation apparatus is actuated from a remote location, e.g., via a radio link by an operator, or by the approaching aircraft.

The landing system of the invention further comprises image processing apparatus provided in the aircraft, to direct the aircraft landing at a desired location on the mat.

In another aspect the invention is directed to a method for landing an aircraft, comprising:
(a) deploying an inflatable mat to the landing location;
(b) at a desired time prior to landing, inflating said inflatable mat;
(c) directing the aircraft to impact the mat at a desired location within an impact angle suitable to bring the aircraft to a halt without causing substantial structural damage to it.

### BRIEF DESCRIPTION OF THE DRAWINGS

In the drawings:

FIG. 1 schematically illustrates the landing of an aircraft according to one embodiment of the invention;

FIG. 2 schematically shows an active landing mat according to one embodiment of the invention;

FIG. 3 schematically shows a passive landing mat according to another embodiment of the invention; and

FIG. 4 schematically illustrates the landing of an aircraft on a non-planar mat, according to yet another embodiment of the invention.

### DETAILED DESCRIPTION OF THE INVENTION

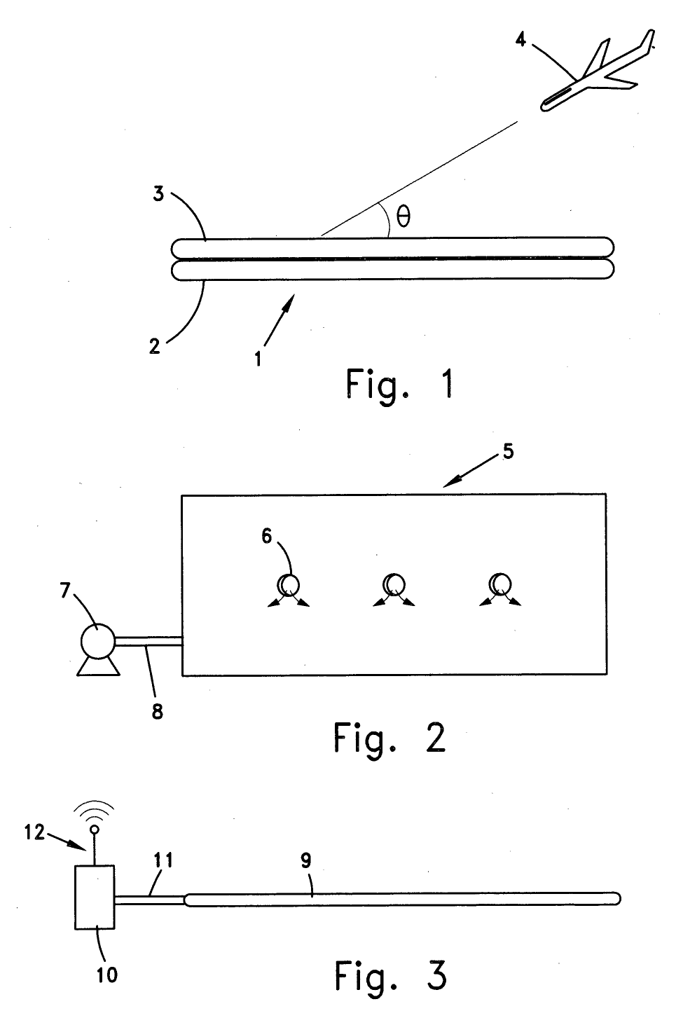

In FIG. 1 a mat 1 is positioned on the ground and awaits the arrival of the aircraft. The mat can be deployed very quickly, in a matter of minutes, by a ground crew that carries it in a ground vehicle. The mat can also be positioned on water, either on a floating platform, or can be configured so that its lower portion is sealed and therefore floating. As will be apparent to the skilled person, and as will be described in greater detail below, in order to be able to absorb the impact of the landing aircraft the inflatable mat must deflate quickly by allowing air to flow out of a plurality of openings, such as simple pressure valves that open when the pressure inside the inflated mat exceed a threshold value due to the impact of the aircraft. When positioning the inflated or inflatable mat directly on water such openings and/or valves should be positioned sufficiently far away from water to avoid flooding into the mat. In FIG. 1 this would schematically be represented by a lower portion 2 of the mat, devoid of openings of any kind, and an upper portion 3, sealingly separated from lower portion 2, in which gas outlet openings and/or valves can be provided. This will be discussed in greater detail in the following description.

As seen in FIG. 1 the aircraft 4 approaches the mat with an approach angle θ, which is dictated by ground conditions, atmospheric conditions and aircraft speed and characteristics. The approach angle is usually predetermined and preprogrammed, according to the type of aircraft and its aerodynamic structure and height and flight control apparatus available to it.

Causing the aircraft to land at the desired location on the mat can be performed in a variety of ways, as will be apparent to the skilled person, including by manual or automatic navigation. According to one embodiment of the invention automatic landing is performed by using image acquisition apparatus typically available in most if not all aircrafts. Once the image of the landing mat is acquired the approach of the aircraft can be directed using relative data, such as by analyzing via image processing, indicia provided on the mat itself, or using GPS data, or by any other suitable method well known to the skilled person, which is therefore not discussed in detail herein for the sake of brevity. The landing is controlled by suitable software operating in the aircraft control system, which received data from the image processing of images acquired by the aircraft's camera, as well as from airborne or ground-based sensors, such as, but not limited to, GPS or DGPS transmitters, radio-enabled sensors, optical sensors and radar sensors. Based on such data the aircraft's software determines the approach trajectory and the landing angle.

Looking now at FIG. 2, an active inflatable mat 5 is shown, which is provided with air outlets 6 and with a blower 7 that continuously blows air into mat 5 via piping 8, so as to keep it inflated, while air is continuously let out of mat 5 through air outlets 6. Blower 7 can be actuated by a ground crew before the arrival of the aircraft, or its operation can be started by the aircraft itself when it approaches the location of the mat, or by a ground operator, in both cases via radio or other communication link. In cases where separation between two compartments of the mat is desired, such as for landing on water, mat 5 of FIG. 2 can be, for instance, element 3 of mat 1 of FIG. 1.

FIG. 3 schematically shows an alternative arrangement according to another embodiment of the invention, in which the landing mat is not inflated continuously, but rather is inflated shortly before landing. Inflation can be effected by a variety of means, such as, for example, by timer or through a signal transmitted by the approaching aircraft. Mat 9 is kept in a deflated condition and is connected to a pressurized gas bottle 10, via piping 11. Gas bottle 10 is connected to a release valve (not shown), which can be opened by any suitable actuator, e.g., via radio link schematically indicated at 12, and thus a rapid inflation of mat 9 can be obtained, in a manner similar to the customary inflation of airbags.

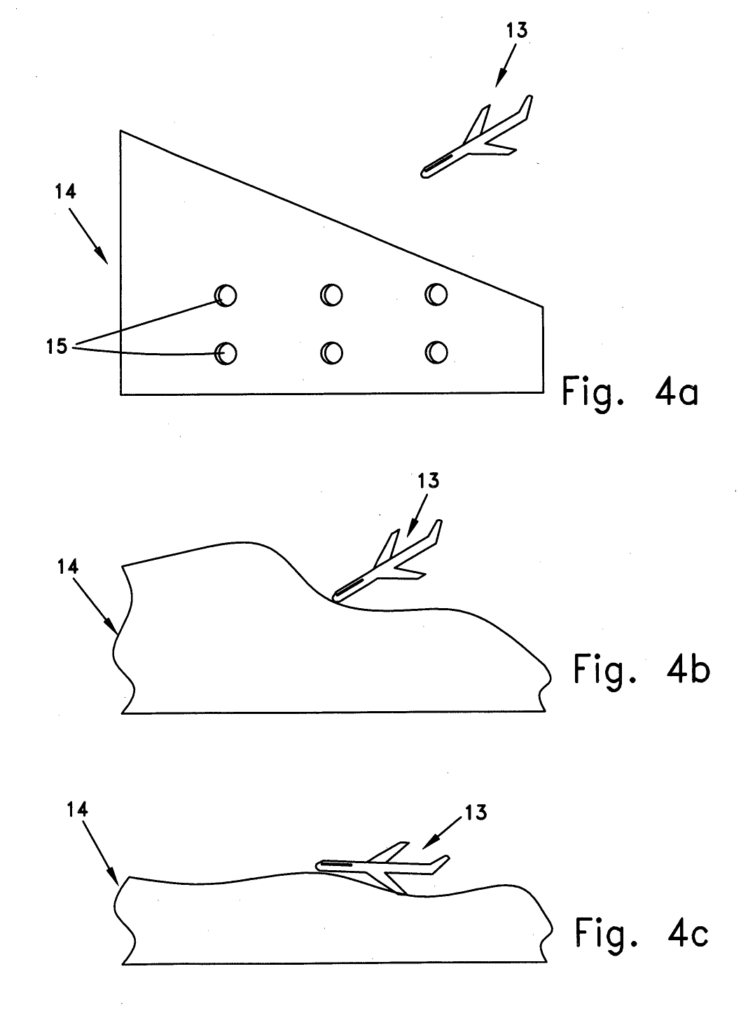

FIG. 4 schematically illustrates the landing of aircraft 13 on a non-planar mat 14 (FIG. 4(a)), which is suited for difficult terrains, such as non-planar areas. The mat is inflated by any suitable means, e.g. as described above with reference to FIGS. 1-3, and is provided with gas release openings/valves 15. As before, if continuous inflation is performed the gas will be air supplied to the mat by a blower that draws surrounding air, while if a pressurized gas bottle is used, other gases can be employed, such as is conventional for airbags, e.g., NO₂, CO₂, air or any other gas or gas mixture suitable to achieve inflation with the desired speed.

FIG. 4(b) illustrates the moment of impact during which the rapid deflation of mat 14 begins, and FIG. 4(c) shows the aircraft at rest on the mat after landing.

It should be noted that since it is the air (or the gas) that absorbs the impact of the aircraft, it is possible to use relatively thin fabric for the mat, which results in low weight and ease of operation. Similarly, the volume of air needed in order to be able to absorb the impact of the aircraft can be easily determined, based on the weight of the aircraft and the speed that it will have at landing. A variety of materials can be employed, as will be apparent to persons skilled in the art, and different materials can be selected for different applications. However, material conventionally employed in manufacturing vehicle or airborne airbags can be used. Additionally, mesh material and the like can also be used. Furthermore, it is possible to provide an inflatable frame with an upper (landing) surface made of a different material, such as a soft layer. As will be apparent to the skilled person there is no limitation to the structure of the landing mat of the invention as long as its inflatable nature is preserved, along with a suitable impact-absorbing landing surface.

As will be apparent to the skilled person, the invention provides great flexibility in deployment and in use. Illustrative examples of such flexibility are the following:

Modular Landing Area Size

Different aircrafts (and different landing conditions) may require landing areas of different sizes. According to the invention it is not necessary to provide different landing mats of different areas. Instead, it is possible to combine two or more landing mats—of the same or of different sizes—to create a larger landing mat area. This ability is important inasmuch as it obviates the need for providing, stocking and deploying mats of different sizes adapted to different landing situations.

Mobile Sea Landing

In some situations it may be desired to move a landing area on water (sea or lake) from one location to another, or to provide a landing area at short notice. The mat of the invention can be made to float and, therefore, it can be towed by a ship to the desired location. Thus, rather than providing a static landing location, the invention allows for a dynamic change of landing location on water.

Flexible Collection

Because of its simple and efficient nature, not only can the landing mat be deployed well ahead of the landing time, but also does not have to be collected immediately after landing. For instance, if on water it can be easily left in position using suitable and conventional anchoring means. If left on solid ground it can also be anchored easily and, additionally, can be deflated by stopping the inflation system used, and collected at a later time.

Ease of Deployment

The landing mat of the invention can be easily deployed from the air, by parachuting it onto the desired landing location. This, as will be apparent to the skilled person, makes it possible to create a suitable landing area at very short notice and to allow aircrafts to land at locations that were not adapted for landing a short while before the desired landing time.

All above description and examples have been provided for the purpose of illustration and are not meant to limit the invention in any way. Many different materials, inflation arrangements and inflatable mat structures can be provided, and many different approach, communication and landing systems can be employed, all without exceeding the scope of the invention.

1. A portable aircraft landing system, comprising an inflatable mat provided with gas outlets, in cooperation with inflation apparatus.

2. A landing system according to claim 1, wherein the inflation apparatus includes a blower and the gas is air.

3. A landing system according to claim 1, wherein the inflation apparatus includes a pressurized gas bottle.

4. A landing system according to claim 3, wherein the gas is selected from N₂, CO₂ and air.

5. A landing system according to claim 1, which is suitable for landing on water, wherein the inflatable mat is coupled to, and provided above a floating surface.

6. A landing system according to claim 5, wherein the floating surface is inflatable.

7. A landing system according to claim 1, wherein the inflation apparatus is actuated from a remote location.

8. A landing system according to claim 7, wherein the inflation apparatus is actuated via a radio link by an operator, or by the approaching aircraft.

9. A landing system according to claim 1, further comprising image processing apparatus provided in the aircraft, to direct the aircraft landing at a desired location on the mat.

10. A method for landing an aircraft, comprising:
(a) deploying an inflatable mat to the landing location;
(b) at a desired time prior to landing, inflating said inflatable mat;
(c) directing the aircraft to impact the mat at a desired location within an impact angle suitable to bring the aircraft to a halt without causing substantial structural damage to it.

11. A method according to claim 10, further comprising combining two or more landing mats of the same or of different sizes, to create a landing mat area of a desired size.

12. A method according to claim 10, wherein the landing area is on water, comprising causing the mat to float and towing it by a ship to the desired location.

13. A method according to claim 10, further comprising anchoring the mat to its location for later recovery.

14. A method according to claim 10, wherein the mat is deployed from the air by parachuting it onto the desired landing location.
